(19) United States
(12) Patent Application Publication
(10) Pub. No.: US 2006/0069778 A1
(43) Pub. Date: Mar. 30, 2006

(54) Content distribution system

(76) Inventor: Shigeaki Ikegawa, Neyagawa-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/184,475

(22) Filed: Jul. 19, 2005

(30) Foreign Application Priority Data
Aug. 30, 2004 (JP) 2004-249547
May 18, 2005 (JP) 2005-146037

(51) Int. Cl. G06F 15/173

(52) U.S. Cl. 709/225

(57) ABSTRACT

A content distribution system includes a center server and a plurality of terminal devices connectable to the center server. The center server specifies, from among a plurality of content portions into which a content item is divided, a target content portion to be received next by a recipient terminal device being one of the plurality of terminal devices, the target content portion being immediately before or immediately after one or more content portions already stored in the recipient terminal device. The center server also specifies a sender terminal device being one of the plurality of terminal devices that stores the specified target content portion. Then, the center server instructs the specified sender terminal device to send the specified target content portion to the recipient terminal device. The sender terminal device sends the specified target content portion to the recipient terminal device. The recipient terminal device receives and stores the target content portion from the specified sender terminal device.

### BACKGROUND OF THE INVENTION

1. Field of the Invention

The present invention relates to a content distribution system for distributing content items stored in a content server to terminal devices.

2. Description of the Related Art

The server-client architecture and the peer-to-peer architecture have been proposed in the art as methods for downloading content items such as music and moving pictures via the Internet. With the server-client architecture, content items are sent from a content server to a plurality of clients. If the number of clients increases, the total size of content items that the server sends at a time increases (i.e., the load on the server increases), and it will be necessary to significantly increase the bandwidth (line capacity) of the communications line to which the server is connected. With the peer-to-peer architecture, content items are exchanged between terminal devices, whereby the load on a particular device is reduced as compared with the load on the server in a server-client system.

With the peer-to-peer architecture, however, content requests from terminal devices may be concentrated at a particular terminal device, and it is desired to further reduce the load on a particular terminal device. Moreover, when a terminal device sends a content item of a large size, it takes a long time for the terminal device to completely send the entire content item. Therefore, if the load on the terminal device were to be reduced, it would be necessary to restrict the terminal device from sending/receiving other content items to/from other terminal devices until the sending of the large content item is completed.

Japanese Laid-Open Patent Publication No. 2003-216521 discloses a method for reducing the load and the amount of traffic of each server, in which content items are distributed among a plurality of servers. Content items are divided into portions or combined together based on the dynamic importance values of the content items, and the resultant content items are redistributed among the servers so that accesses from terminal devices are distributed. Also with this method, there may be an increased load on a particular server if content requests from terminal devices are concentrated at the server.

Japanese Laid-Open Patent Publication No. 2004-213508 discloses the following method to prevent accesses from being concentrated at a particular server. A server SV stores files to be sent to clients while each file is divided into blocks in the server SV. When sending a file to clients C1 and C2, the server SV sends blocks of the file to the client C2 in the order of blocks starting from the first block while sending the blocks of the file to the client C1 in the reverse order starting from the last block. Therefore, a block being sent to the client C1 is unlikely to be sent to the client C2 at the same time. Upon receiving each complete block, the client C1 stores the block in a storage device therein and immediately sends the block to the client C2. As a result, blocks are sent from the client C1 to the client C2 in the reverse order. Similarly, upon receiving each complete block, the client C2 stores the block in a storage device therein and immediately sends the block to the client C1. As a result, blocks are sent from the client C2 to the client C1 in the order of blocks. Note that the combination of the client C1 and the client C2 is determined by the client C1 based on factors such as a tested transfer rate between the clients and a measured distance therebetween by referring to a list that is sent from the server. If the server has a limited bandwidth, the requested file may be entirely sent from the client C2 to the client C1, for example, where the client C2 has a copy of the requested file.

The method of Japanese Laid-Open Patent Publication No. 2004-213508 merely selects, for each client, whether to send blocks in the normal order starting from the first block or to send blocks in the reverse order starting from the last block, in a client-to-client block transfer or in a server-to-client block transfer. As a result, if three or more clients request the same file at the same time, it is inevitable that the same block needs to be sent to different clients at the same time, whereby block-sending requests are concentrated at a server or a client. Moreover, since blocks are sent sequentially starting from the first block or the last block, it takes a long time before the entire file is sent. If there arises a need to send a file (blocks) to another client in the meantime, the load on the sender (a server or a client) will increase.

### SUMMARY OF THE INVENTION

It is therefore an object of the present invention to provide a content distribution system in which it is possible to prevent content requests from being concentrated at a particular terminal device or a particular content server.

A content distribution system according to a preferred embodiment of the present invention includes a center server and a plurality of terminal devices connectable to the center server. The center server includes a section for specifying, from among a plurality of content portions into which a content item is divided, a target content portion to be received next by a recipient terminal device being one of the plurality of terminal devices, the target content portion being immediately before or immediately after one or more content portions already stored in the recipient terminal device; and a section for specifying a sender terminal device being one of the plurality of terminal devices that stores the specified target content portion. Each terminal device includes a section for receiving and storing the specified target content portion from the specified sender terminal device.

Preferably, the content distribution system further includes a content server to which the plurality of terminal devices can be connected. The content server includes a section for storing the content portions, and a section for sending each of the content portions to a different terminal device. Each terminal device includes a section for storing the content portion sent from the content server.

Preferably, the center server further includes a section for receiving and storing operation status information from each of the terminal devices. The sender terminal device specifying section specifies the sender terminal device based on the operation status information of the terminal devices.

Preferably, if there are a plurality of terminal devices specified as sender terminal devices, the sender terminal device specifying section narrows down the sender terminal devices based on a transfer efficiency between the recipient terminal device and each sender terminal device.

Preferably, the center server further includes a section for storing a difference value between the number of remaining earlier portions and the number of remaining later portions for each terminal device, wherein the number of remaining earlier portions represents the number of earlier content portions that have not been stored in the terminal device and the number of remaining later portions represents the number of later content portions that have not been stored in the terminal device. The content portion specifying section chooses either a content portion immediately before the one or more already-stored content portions or a content portion immediately after the one or more already-stored content portions based on a sum of the difference values for all the terminal devices.

Preferably, if the sender terminal device cannot be specified, the content portion specifying section chooses either a content portion immediately before the one or more already-stored content portions or a content portion immediately after the one or more already-stored content portions based on the difference value for the recipient terminal device.

Preferably, the center server is connectable to a content server storing the content item and further includes: a section for calculating a divisor being the number of portions into which the content item is divided, based on a bandwidth of a communications line to which the content server is connected and a transfer rate at which the content item is sent from the content server; a section for instructing the content server to divide the content item into a plurality of content portions based on the calculated divisor; and a section for instructing each terminal device to receive different one of the content portions from the content server.

Functions of the present invention will now be described.

In the content distribution system of the present invention, a terminal device does not receive an entire content item but only receives one content portion from the content server, and receives the other content portions from other terminal devices. A terminal device sends content portions stored therein to other terminal devices. Therefore, content requests will not be concentrated at the content server, whereby it is possible to prevent an increase in the load on the content server.

Also between terminal devices, not an entire content item but a content portion is exchanged. Therefore, the amount of time required before a terminal device completely sends a content portion is much shorter than the amount of time required for the terminal device to completely send an entire content item. Therefore, after a terminal device completely sends a content portion within a shorter amount of time, the terminal device can receive content portions from other terminal devices or send content portions to other terminal devices. Moreover, a terminal device receives a content portion adjacent to a content portion or content portions already stored in the terminal device from another terminal device. Thus, a terminal device receives and stores either a content portion having an address immediately before an already-stored content portion that has the lowest address or a content portion having an address immediately after an already-stored content portion that has the highest address. Which content portion is to be received next is determined for each content portion receiving operation. Thus, a terminal device does not successively receive content portions in a simple sequence starting from either the first or last content portion. Therefore, for each terminal device, the content portion to be received next is different and is determined based on the content portion or content portions already stored in the terminal device. Moreover, for each content portion to be received by a terminal device, another terminal device is specified as a sender from which the content portion is to be sent. As a result, each terminal device will have a different terminal device serving as its content portion sender. Therefore, content portion requests will not be concentrated at a particular terminal device, whereby it is possible to prevent an increase in the load on a terminal device.

The center server specifies a target content portion to be received next by a recipient terminal device and also specifies a sender terminal device to send the target content portion to the recipient terminal device. Then, the center server instructs the recipient terminal device to receive the specified target content portion from the specified sender terminal device. Therefore, the recipient terminal device does not need to specify the sender terminal device from among a plurality of terminal devices. Thus, a terminal device does not need to keep the operation status information of other terminal devices or information about the content portion or content portions stored in other terminal devices. Therefore, it is possible to simplify the process performed by each of the terminal devices, thus simplifying the overall process of the system.

Preferably, a content server storing the content portions sends different content portions to different terminal devices. Then, each terminal device stores a different content portion. Therefore, each terminal device receives, from a different sender terminal device, a content portion adjacent to a content portion or content portions already stored in the terminal device. Thus, it is possible to desirably prevent content requests from being concentrated at a particular terminal device.

Preferably, the center server specifies a terminal device to be the sender of a content portion based on the operation status information of the terminal device. Specifically, the center server specifies a terminal device whose operation status information is “standby”. Therefore, it is possible to prevent content portion requests from being concentrated at a particular terminal device.

Preferably, the center server specifies a terminal device to be the sender of a content portion based on the transfer efficiency between terminal devices. Therefore, it is possible to shorten the amount of time before an exchange of a content portion between terminal devices is completed. Thus, it is possible to shorten the amount of time before all content portions of a content item are completely stored in all terminal devices.

Preferably, a content item is divided into the same number of content portions as the divisor calculated based on the bandwidth of the communications line to which the content server is connected and the actual transfer rate at which data is transferred from the content server. Therefore, the content server can simultaneously send all content portions to different terminal devices. Thus, it is possible to shorten the amount of time required before content portions are stored in terminal devices.

Preferably, the center server stores the difference value between the number of remaining earlier portions and the number of remaining later portions for each terminal device. The difference value indicates whether there are more earlier content portions yet to be received or there are more later content portions yet to be received. The center server calculates the sum of the difference values for all terminal devices. If the sum of the difference values is a positive value, the center server determines that there are more earlier content portions yet to be received for all of the terminal devices as a whole, and thus determines that a recipient terminal device is to receive an earlier content portion from a sender terminal device. If the sum of the difference values is a negative value, the center server determines that there are more later content portions yet to be received for all of the terminal devices as a whole, and thus determines that a recipient terminal device is to receive a later content portion from a sender terminal device. Therefore, it is possible to prevent a situation where more earlier content portions or more later content portions are stored in an unbalanced manner in the terminal devices.

Preferably, based on the difference value for a recipient terminal device, the center server determines that the recipient terminal device is to receive an earlier content portion from a sender terminal device if the difference value is a positive value, and determines that the recipient terminal device is to receive a later content portion from a sender terminal device if the difference value is a negative value. Thus, it is possible to prevent the recipient terminal device from receiving more earlier content portions or more later content portions in an unbalanced manner for that terminal device.

### BRIEF DESCRIPTION OF THE DRAWINGS

FIG. 1 is a block diagram showing a content distribution system according to a preferred embodiment of the present invention.

FIG. 2 is a block diagram showing a center server according to a preferred embodiment of the present invention.

FIG. 3 is a block diagram showing a content server according to a preferred embodiment of the present invention.

FIG. 4 is a block diagram showing a terminal device according to a preferred embodiment of the present invention.

FIG. 5 is a flow chart showing a content dividing process.

FIG. 6 is a flow chart showing an operation of sending a content portion from a content server to a terminal device.

FIG. 7 is a flow chart showing how a content portion is exchanged between terminal devices.

FIG. 8 is a flow chart showing a content portion specifying process.

FIG. 9 is a flow chart showing a process of specifying a content portion to be received by a terminal device.

FIG. 10 is a flow chart showing a content portion specifying process according to another embodiment of the present invention.

### DETAILED DESCRIPTION OF THE PREFERRED EMBODIMENTS

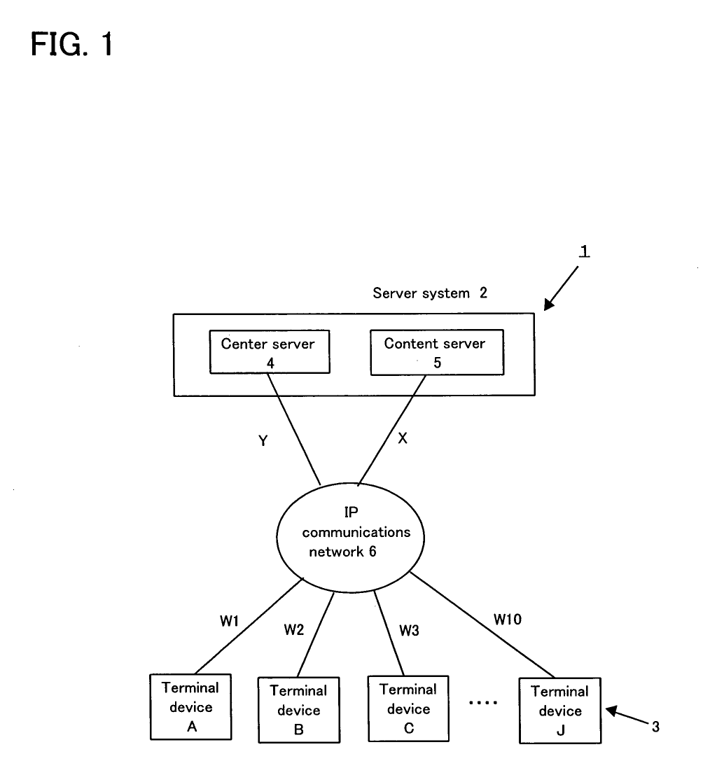

While preferred embodiments of the present invention will now be described in detail with reference to the drawings, it is understood that the present invention is not limited thereto. FIG. 1 is a block diagram showing a content distribution system 1 according to a preferred embodiment of the present invention. The content distribution system 1 includes a server system 2 and a plurality of terminal devices 3 (terminal devices A to J). The server system 2 includes a center server 4 and a content server 5. The center server 4 is a server for storing operation status information of the terminal devices 3, information about content portions (to be described later) stored in the terminal devices 3, etc., and for instructing the terminal devices 3 to send/receive content portions. The content server 5 is a server for storing content items each of which is divided into portions (herein referred to as “content portions”), and for sending content portions to the terminal devices 3. The center server 4 and the content server 5 may be integral with or separate from each other. In other words, the center server 4 and the content server 5 may be operated by the same carrier or by different carriers. The center server 4 and the content server 5 are connected to an IP communications network 6, such as the Internet, via communications lines Y and X, respectively. If the center server 4 and the content server 5 are integral with each other, a common line is used for the communications lines Y and X. The terminal devices 3 are connected to the IP communications network 6 via communications lines W (W1 to W10). A terminal device 3 can receive content portions from the content server 5 and other terminal devices 3, and store the received content portions. A terminal device 3 can also send content portions to other terminal devices 3. Content items used in the present invention may include music pieces, moving pictures, still images, etc. The present invention is particularly suitable for moving pictures, which have large data sizes.

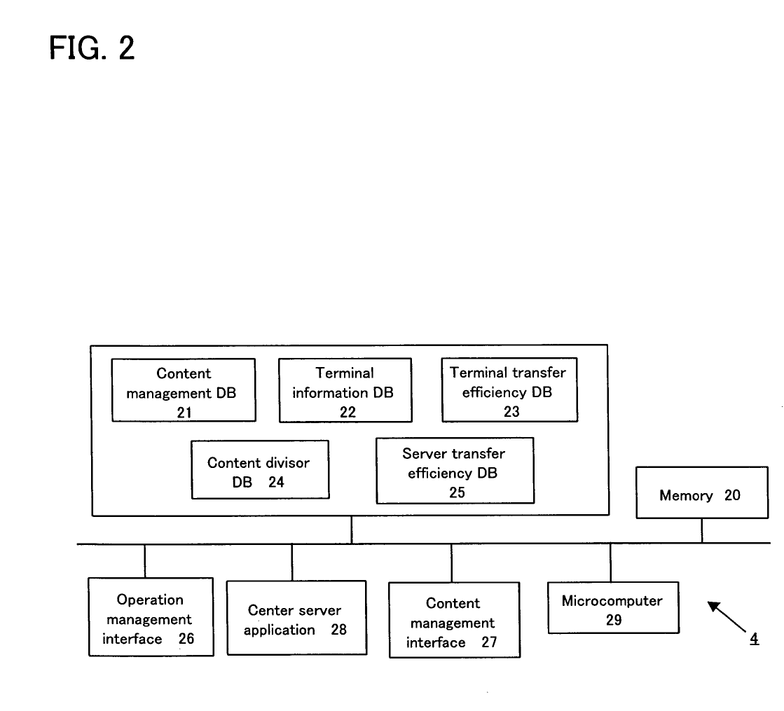

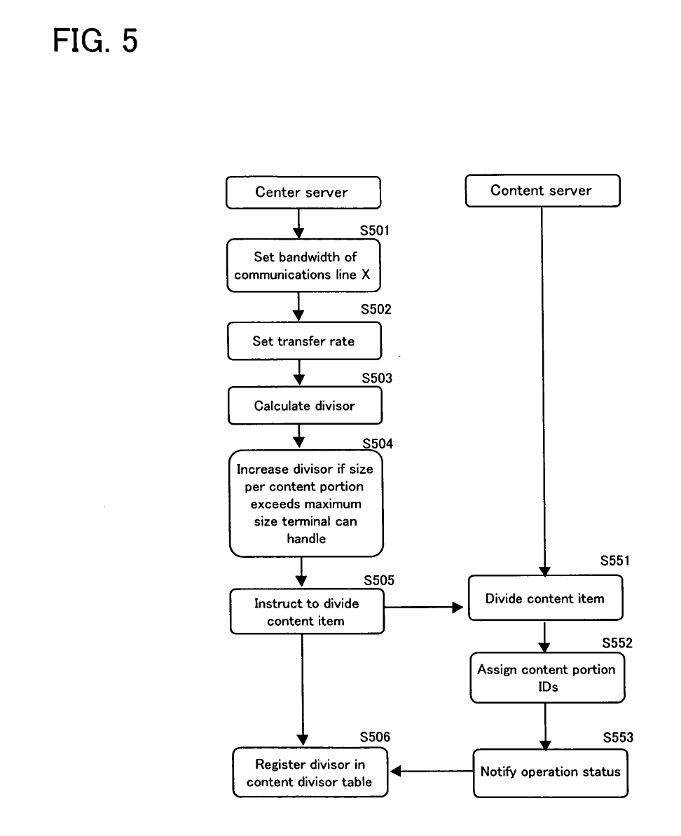

FIG. 2 shows a configuration of the center server 4. The center server 4 includes various databases such as a content management database 21, a terminal information database 22, a terminal transfer efficiency database 23, a content divisor database 24 and a server transfer efficiency database 25, an operation management interface 26, a content management interface 27, a center server application 28, a microcomputer 29 for controlling the overall operation, and a memory 20 such as a ROM or a RAM. The databases and the center server application 28 are stored in a hard disk (not shown). The operation management interface 26 is an interface for receiving operation status information from the terminal devices 3. The content management interface 27 is an interface for receiving content information (e.g., the titles, the lengths, etc., of content items) from the terminal devices 3. The center server application 28 registers the operation status information received from the operation management interface 26 in the terminal information database 22, and registers the content information received from the content management interface 27 in the content management database 21 and the terminal information database 22. The center server application 28 implements various operations of the center server shown in FIG. 5 to FIG. 10. The center server 4 stores a content information table (not shown) in the content management database 21. In the content information table, content information (e.g., the titles, the lengths, etc., of content items) is stored while being associated with content portion IDs (to be described later).

The center server 4 stores a terminal information table as shown in Table 1 below in the terminal information database 22. The terminal information table is a table where the center server 4 stores information about the terminal devices 3.

TABLE 1
TERMINAL INFORMATION TABLE

| Terminal | | Network | IP | |
|---|---|---|---|---|
| name | Content portion ID | condition | address | Operation status |
| A | Z2, Z3, Z4 | Carrier B | 10.1.0.2 | Ready |
| B | Z1, Z2, Z3 | Carrier B | 10.1.1.9 | Standby |
| C | Z5, Z6, Z7 | Carrier C | 10.2.2.1 | Active |
| D | Z7, Z8 | Carrier B | 10.1.1.8 | Standby |
| E | Z3, Z4, Z5, Z6, Z7 | Carrier C | 10.2.2.3 | Standby |
| F | Z3, Z4, Z5, Z6 | Carrier B | 10.1.2.7 | Standby |
| G | Z8 | Carrier B | 10.1.1.6 | Active |
| H | Z2 | Carrier B | 10.1.0.4 | Active |
| I | | Carrier A | 10.0.0.3 | Active |
| J | | Carrier C | 10.2.2.2 | Active |

The terminal information table has the terminal name field, the content portion ID field, the network condition field, the terminal identifying information field, and the operation status information field. The terminal name field represents the name (e.g., the host name) of the terminal device (the terminal devices are herein designated simply as “A” to “J” for the sake of simplicity). The content portion ID field represents the identification numbers of content portions that are already stored in the terminal device. For example, assume that a content item Z is divided into eight content portions that are designated by content portion IDs of Z1 to Z8. It can be seen from the table that the terminal device A stores the content portions Z2 to Z4, and the terminal device B stores the content portions Z1 to Z3. The network condition field represents a condition that dictates the transfer efficiency between terminal devices or between the content server and the terminal device. For example, the network condition may be the connection type (e.g., FTTH or ADSL), the Internet service provider, the telecommunications carrier, or the regional information (e.g., the name of the prefecture). In the illustrated example, the name of the telecommunications carrier (A to C) is used as the network condition. The terminal identifying information field stores information that is used to identify the terminal device when the terminal device sends/receives a content portion, and may be the IP address, for example. The operation status information field represents the operation status of the terminal device, which can be “ready”, “standby” or “active”, for example. The center server 4 can determine that a terminal device 3 being “ready” can be instructed to receive a content portion, that a terminal device 3 being on “standby” can be specified as a content portion sender, and that a terminal device 3 being “active” (i.e., being engaged in a communications session) cannot be instructed to receive a content portion or specified as a content portion sender. The fields of the terminal information table contain no values initially, and initial values are registered therein when operation status information is received from a terminal device 3.

The center server 4 stores a terminal transfer efficiency table as shown in Table 2 below in the terminal transfer efficiency database 23.

TABLE 2
TERMINAL TRANSFER EFFICIENCY TABLE

| Sender | Recipient | Transfer efficiency |
|---|---|---|
| Carrier A | Carrier A | 0 |
| Carrier A | Carrier B | 50 |
| Carrier A | Carrier C | 100 |
| Carrier B | Carrier A | 30 |
| Carrier B | Carrier B | 0 |
| Carrier B | Carrier C | 100 |
| Carrier C | Carrier A | 50 |
| Carrier C | Carrier B | 70 |
| Carrier C | Carrier C | 0 |

The terminal transfer efficiency table represents the transfer efficiency between terminal devices, and is used by the center server 4 for specifying a terminal device to be used to send a content portion to a recipient terminal device. The terminal transfer efficiency table has the sender network condition (telecommunications carrier) field, the recipient network condition (telecommunications carrier) field, and the transfer efficiency field specifying the transfer efficiency with which a content portion is sent from the sender to the recipient. For example, the transfer efficiency (i.e., the transfer cost) is determined based on the transfer rate ratio for data transfer from the sender to the recipient. The transfer rate ratio is, for example, the ratio between the transfer rate for data transfer between terminals both using carrier A and that for data transfer between a terminal using carrier A and a terminal using carrier B. The smaller this value is, the higher the transfer efficiency is (the lower the transfer cost is). A higher transfer efficiency (a lower transfer cost) means a shorter amount of time required for sending a content portion. For example, a longer time is required for sending a content portion from a terminal device using the telecommunications carrier A to a terminal device using the telecommunications carrier C than for sending the content portion from a terminal device using the telecommunications carrier A to a terminal device using the telecommunications carrier B.

The center server 4 stores a content divisor table as shown in Table 3 below in the content divisor database 24.

TABLE 3
CONTENT DIVISOR TABLE

| Content ID | Divisor |
|---|---|
| Z | 8 |
| Y | 12 |

The content divisor table is a table where the center server 4 stores content divisors (a content divisor is the number of content portions into which a content item is to be divided). Based on the content divisor table, the center server 4 determines whether or not a terminal device 3 has stored all content portions (i.e., an entire content item). Moreover, based on the content divisor table, the center server 4 determines whether or not there is a content portion that should be next stored in a terminal device 3. For example, it can be seen from Table 3 that the content item Z is divided into eight content portions (in other words, the content portions Z1 to Z8 together form the content item Z).

The center server 4 stores a server transfer efficiency table as shown in Table 4 below in the server transfer efficiency database 25.

TABLE 4
SERVER TRANSFER EFFICIENCY TABLE

| Sender | Recipient | Transfer efficiency |
|---|---|---|
| Content server | Carrier A | 100 |
| Content server | Carrier B | 10 |
| Content server | Carrier C | 50 |

The server transfer efficiency table represents the transfer efficiency from the content server 5 to the terminal device 3, and is used by the center server 4 for specifying a terminal device 3 to be the recipient of a content portion from the content server 5. The server transfer efficiency table specifies the sender (content server), the network condition (telecommunications carrier) of the recipient (terminal device), and the transfer efficiency with which a content portion is sent from the sender to the recipient. For example, the transfer efficiency (i.e., the transfer cost) represents the transfer rate ratio for data transfer from the sender to the recipient. The smaller this value is, the higher the transfer efficiency is (the lower the transfer cost is). A higher transfer efficiency (a lower transfer cost) means a shorter amount of time required for sending a content portion. For example, a longer time is required for sending a content portion from the content server to a terminal device using the telecommunications carrier A than for sending the content portion from the content server to a terminal device using the telecommunications carrier C.

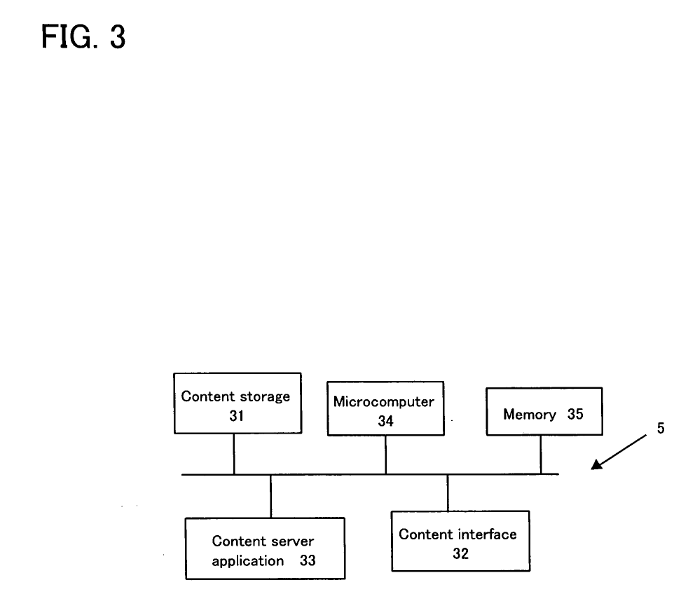

FIG. 3 shows a configuration of the content server 5. The content server 5 include a content storage device 31, a content interface 32, a content server application 33, a microcomputer 34 for controlling the overall operation, and a memory 35 such as a ROM or a RAM. The content storage device 31 is a hard disk (not shown), and the content server application 33 is stored therein. The content storage device 31 stores content items or stores content portions into which each content item is divided by a predetermined divisor to be described later. The content interface 32 is an interface used when storing content items and content information received from outside in the content storage device 31 and when sending content portions to the terminal devices 3. The content server application 33 divides content items each into a plurality of content portions and stores the content portions in the content storage device 31 according to an instruction from the center server 4. Moreover, the content server application 33 sends content portions to different terminal devices 3.

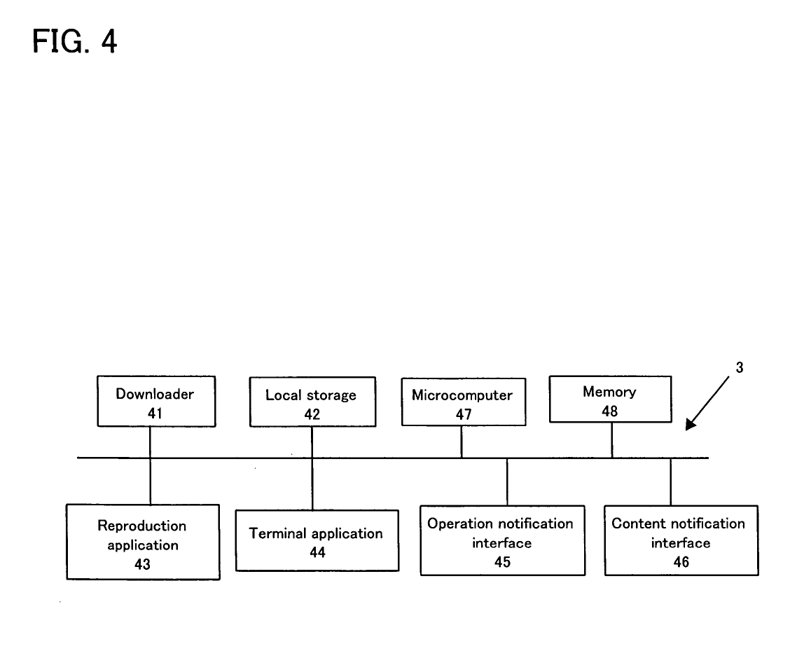

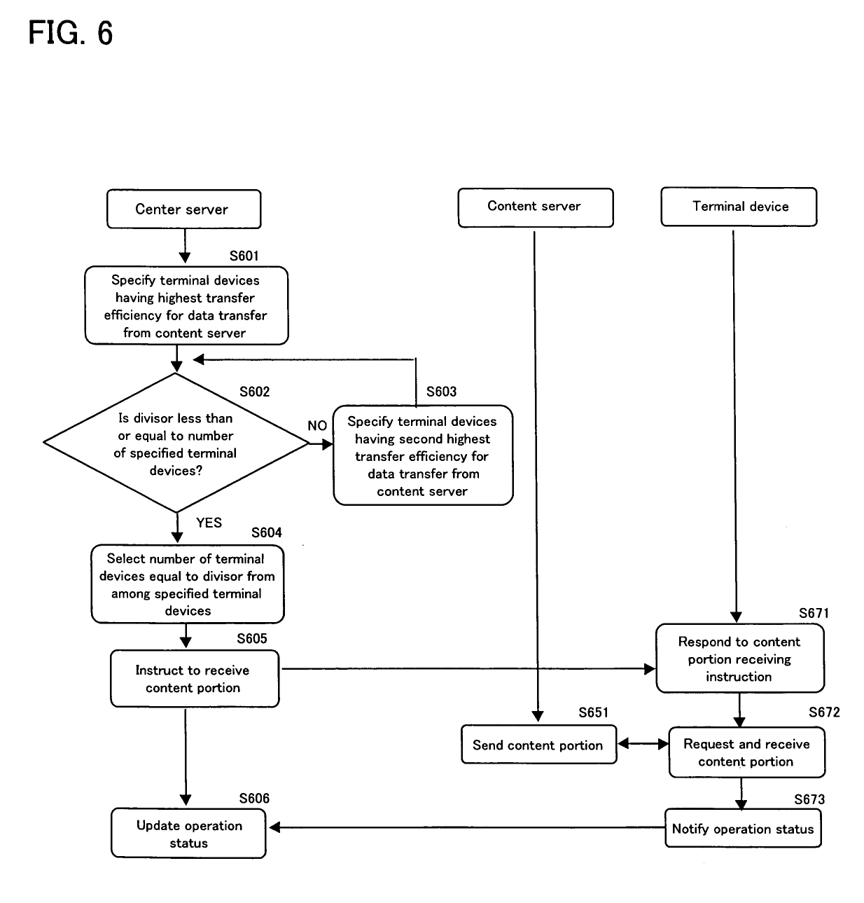

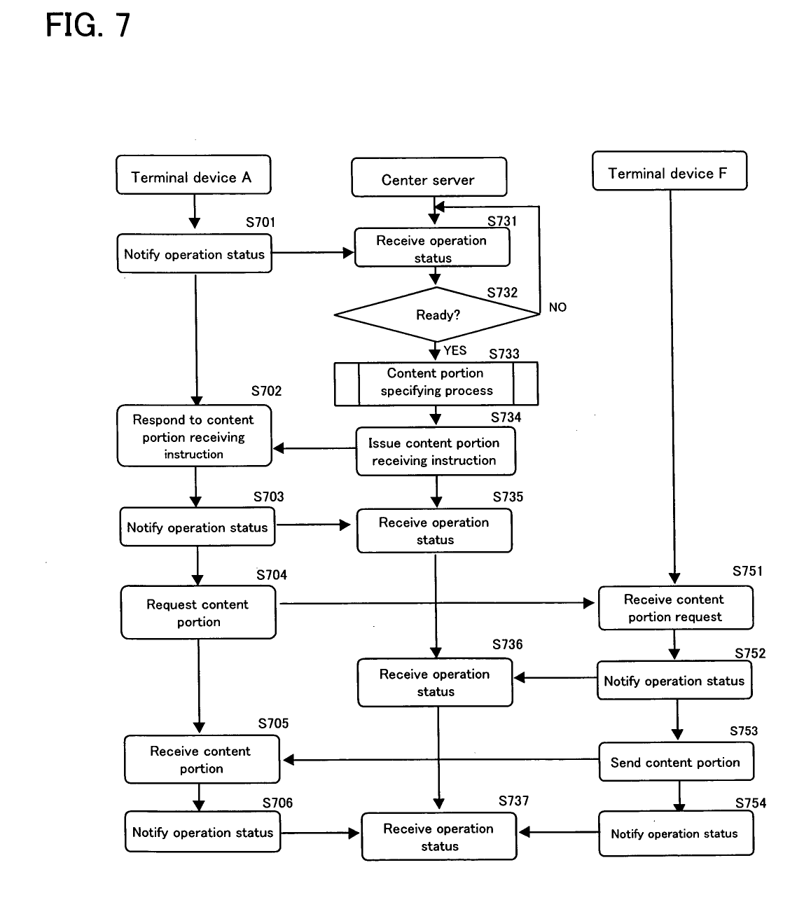

FIG. 4 shows a configuration of the terminal device 3. The terminal device 3 includes a downloader 41, a local storage device 42, a reproduction application 43, a terminal application 44, an operation notification interface 45, a content notification interface 46, a microcomputer 47 for controlling the overall operation, and a memory 48 such as a ROM or a RAM. The downloader 41 receives content portions from the content server 5 or other terminal devices 3. The local storage device 42 is a hard disk for storing received content portions and the content information thereof. The reproduction application 43 loads a desired content item from the local storage device 42, and reproduces the content item, which may be a moving picture, a music piece or a still image. The terminal application 44 sends the operation status information of the terminal device 3 to the center server 4 via the operation notification interface 45, and sends the content information of the content portions that have been stored in the terminal device 3 to the center server 4 via the content notification interface 46. Moreover, the terminal application 44 implements various operations shown in FIG. 6 and FIG. 7.

A content distribution method of the content distribution system will now be described with reference to flow charts of FIG. 5 to FIG. 9. First, an outline of the content distribution method will be described. The center server 4 calculates the content divisor. The content server 5 divides a content item into the same number of content portions as the divisor calculated by the center server 4 (FIG. 5). When the operation status of a terminal device 3 changes, the terminal device 3 sends the operation status information thereof to the center server 4. The center server 4 receives and stores the operation status information from the terminal device 3. The content server 5 sends content portions to the terminal device 3 (FIG. 6). The terminal device 3 receives and stores the content portions from the content server 5, receives other content portions that have not been stored in the terminal device 3 from other terminal devices, and sends content portions stored in the terminal device 3 to other terminal devices (FIG. 7 to FIG. 9). The operation will now be described in greater detail.

FIG. 5 shows a content dividing operation performed by the server system 2. In S501, the center server 4 sets the bandwidth (line capacity) (bits per second) of the communications line X, to which the content server 5 is connected and over which the content server 5 sends content portions. While this value is typically input by the administrator of the center server 4, it may alternatively be automatically determined by the center server 4.

In S502, the center server 4 sets the transfer rate (bits per second) at which content portions are sent from the content server 5 to the terminal devices 3. In other words, the center server 4 sets the actual transfer rate of the communications line X, to which the content server 5 is connected. While this value is typically input by the administrator of the center server 4, it may alternatively be automatically determined by the center server 4.

In S503, the center server 4 calculates the content divisor based on the bandwidth “a” of the communications line X determined in S501 and the transfer rate “b” determined in S502. Specifically, the center server 4 calculates the divisor (an integer) by dividing the bandwidth “a” of the communications line X by the transfer rate “b”. Thus, the content divisor P is expressed as follows: P=a/b. For example, where the bandwidth “a” of the communications line X is 40 Mbps and the transfer rate “b” is 5 Mbps, the content divisor P is 8.

In S504, the center server 4 determines whether or not each of content portions obtained by dividing a content item by the divisor calculated in S503 will be of such a size that can be handled by the terminal device 3. Specifically, the center server 4 obtains the total size of the content item and divides it by the divisor to obtain the size of each content portion. Then, it is determined whether or not the terminal device 3 can handle the content portion size. The maximum size that can be handled by the terminal device 3 is, for example, the maximum size of a file that can be handled by a 32-bit OS (operating system). If it is determined that the size of each content portion will be greater than or equal to the maximum size that can be handled by the terminal device 3, the content divisor is increased from that calculated in S503. For example, assume that the maximum size that can be handled by the terminal device 3 is 2 GB and the content divisor is 8. If a content item has a total size of 12 GB, the size of each content portion will be 1.5 GB, which is less than the maximum size that can be handled by the terminal device 3, in which case the divisor is determined to be 8. If a content item has a total size of 32 GB, the size of each content portion will be 4 GB, which is greater than the maximum size that can be handled by the terminal device 3, in which case the center server 4 increases the content divisor to 20, for example, so that the size of each content portion will be less than the maximum size that can be handled by the terminal device 3.

In S505, the center server 4 instructs the content server 5 to divide the content item based on the divisor calculated in S503 and S504. Specifically, the center server 4 sends the content server 5 a content division command, which contains the content ID of the content item to be divided and the divisor. In response to the content division command from the center server 4, the content server 5 loads the specified content item from the content storage device 31 and divides the content item into the same number of content portions as the specified divisor (typically into content portions of an equal size). Then, the content server 5 stores the obtained content portions in the content storage device 31 (S551). The content server 5 assigns each content portion a content portion ID (Z1 to Z8) according to the address of the content portion (S552). The content server 5 sends the operation status information to the center server 4 to notify the center server 4 of the completion of the content division operation (S553). In response to the operation status notification, the center server 4 registers the divisor (8) of the content item Z, for example, in the content divisor table (S506).

As described above, the content divisor is calculated based on the bandwidth of the communications line X and the actual transfer rate at which data is transferred from the content server 5, whereby the content server 5 can simultaneously send the obtained content portions to the terminal devices 3. Simultaneously sending eight content portions each at a transfer rate of 5 Mbps, for example, will not exceed the bandwidth of the communications line X (40 Mbps). Thus, the content server 5 divides a content item by a highest possible divisor for the bandwidth of the communications line X, and simultaneously sends the obtained content portions to the terminal devices 3. This reduces the amount of time required for the terminal devices 3 to completely store the received content portions, whereby it is possible to shorten the amount of time before transitioning to the next operation in which content portions are exchanged between terminal devices 3. If the divisor is increased in S504, the content server 5 simultaneously sends a number of content portions equal to the divisor as calculated in S503 to the terminal devices 3.

FIG. 6 is a flow chart showing an operation of sending a content portion from the server system 2 to the terminal device 3. In S601 to S604, a terminal device 3 to which a content portion is to be sent is specified. Specifically, in S601, the center server 4 specifies a terminal device 3 having a network condition that provides the highest transfer efficiency for data transfer from the content server 5. Specifically, the center server 4 refers to the server transfer efficiency table and specifies the telecommunications carrier B (transfer efficiency: 10) as the network condition that provides the highest transfer efficiency for data transfer from the content server 5. The center server 4 refers to the terminal information table and specifies six terminal devices A, B, D, F, G and H as terminal devices whose network condition is the telecommunications carrier B.

In S602, it is determined whether or not the content divisor calculated in the process of FIG. 5 is less than or equal to the number of terminal devices specified in S601. In the illustrated example, the content divisor (8) is greater than the number of terminal devices specified in S601 (6). Therefore, in S603, the center server 4 further specifies terminal devices 3 having a network condition that provides the second highest transfer efficiency for data transfer from the content server 5. Specifically, the center server 4 specifies the telecommunications carrier C (transfer efficiency: 50) as the network condition that provides the second highest transfer efficiency for data transfer from the content server 5. The center server 4 refers to the terminal information table and specifies three terminal devices C, E and J as terminal devices whose network condition is the telecommunications carrier C. Then, it is determined in S602 that the content divisor (8) is less than or equal to the total number of terminal devices specified in S601 and S603 (9), thus proceeding to S604.

In S604, the center server 4 selects eight (=content divisor) terminal devices from among the nine terminal devices that have been specified in S601 and S603. Specifically, the center server 4 excludes the terminal device J, which is registered in the last entry of the terminal information table, from among the three the terminal devices C, E and J specified later in S603. As a result, the center server 4 specifies a total of eight terminal devices A, B, C, D, E, F, G and H.

In S605, the center server 4 instructs each of the terminal devices A to H to receive a content portion. Specifically, the center server 4 sends each of the terminal devices A to H a content portion receiving command, which contains the IP address of the content server 5 and the content portion ID of a different content portion. Note that any terminal device may be combined with any content portion. In response to the content portion receiving command (S671), each terminal device requests the content server 5 to send the specified content portion (S672). Specifically, the terminal device sends the content server 5 a content request command containing the content portion ID of the content portion. In response to the content request command, the content server 5 sends the requested content portion to the terminal device. The content server 5 receives content portion requests from the terminal devices A to H substantially simultaneously, and the content server 5 substantially simultaneously sends different content portions Z1 to Z8 to the terminal devices A to H. By simultaneously sending the content portions Z1 to Z8, it is possible to shorten the amount of time required for the terminal devices A to H to completely receive and store the content portions. The content portions Z1 to Z8 can be sent simultaneously because the content divisor is determined in S501 to S503 of FIG. 5 based on the bandwidth of the communications line X and the transfer rate at which data is transferred from the content server 5. Each terminal device 3 receives and stores a content portion in the local storage device 42, and sends the operation status information (“content portion received; standby”) to the center server 4 (S673). The center server 4 receives the operation status information from the terminal device 3 and updates the terminal information table (S606). Specifically, the center server 4 updates the operation status information in the terminal information table to “standby”, and registers the content portion ID of the content portion just stored in the terminal device in the content portion ID field.

Table 5 below shows the updated terminal information table after the terminal devices 3 have received and stored content portions from the content server 5.

TABLE 5
TERMINAL INFORMATION TABLE

| Terminal | Content | | IP | |
|---|---|---|---|---|
| name | portion ID | Network condition | address | Operation status |
| A | Z3 | Carrier B | 10.1.0.2 | Standby |
| B | Z1 | Carrier B | 10.1.1.9 | Standby |
| C | Z6 | Carrier C | 10.2.2.1 | Standby |
| D | Z7 | Carrier B | 10.1.1.8 | Standby |
| E | Z5 | Carrier C | 10.2.2.3 | Standby |
| F | Z4 | Carrier B | 10.1.2.7 | Standby |
| G | Z8 | Carrier B | 10.1.1.6 | Standby |
| H | Z2 | Carrier B | 10.1.0.4 | Standby |
| I | | Carrier A | 10.0.0.3 | Standby |
| J | | Carrier C | 10.2.2.2 | Standby |

As shown in Table 5 above, the terminal devices A to H store different content portions. Then, each terminal device receives and stores, from other terminal devices, a content portion that has not been stored in the terminal device. Preferably, the terminal device stores a content portion that is adjacent to (immediately before or immediately after) a content portion that is already stored in the terminal device. Each terminal device receives a different content portion from another terminal device and sends a different content portion to another terminal device. Since content portions, instead of an entire content item, are exchanged between terminal devices, it requires only a short time before the sending/receiving of a content portion between terminal devices is completed. Therefore, content portion requests will not be concentrated at any particular terminal device, whereby it is possible to distribute the load among different terminal devices and thus to reduce the load on each terminal device. For example, the terminal device A may receive the content portion Z2 from the terminal device H or the content portion Z4 from the terminal device F. The terminal device D may receive the content portion Z6 from the terminal device C or the content portion Z8 from the terminal device G.

FIG. 7 is a flow chart showing how a content portion is exchanged between terminal devices. In S701, the terminal device A sends the operation status information to the center server 4. Herein, the terminal device A notifies the center server 4 that the terminal device A is “ready” after being on “standby” for a certain period of time. This is to prompt the center server 4 to issue a content portion receiving instruction. In S731, the center server 4 receives the operation status information from the terminal device A and updates the operation status information field of the terminal information table. In S732, the center server 4 determines whether or not the operation status information received from the terminal device A is “ready”. If the operation status information is not “ready” (e.g., if it is “active”), the center server 4 waits until operation status information is received again without issuing a content portion receiving instruction to the terminal device A (NO in S732). By not issuing a content portion receiving instruction to a terminal device that is not being “ready”, it is possible to prevent an increase in the load on the terminal device. In the illustrated example, since the operation status information is “ready” (YES in S732), the center server 4 performs a content portion specifying process of specifying a content portion to be received next by the terminal device A and a terminal device to which the terminal device A is to send a content portion (S733).

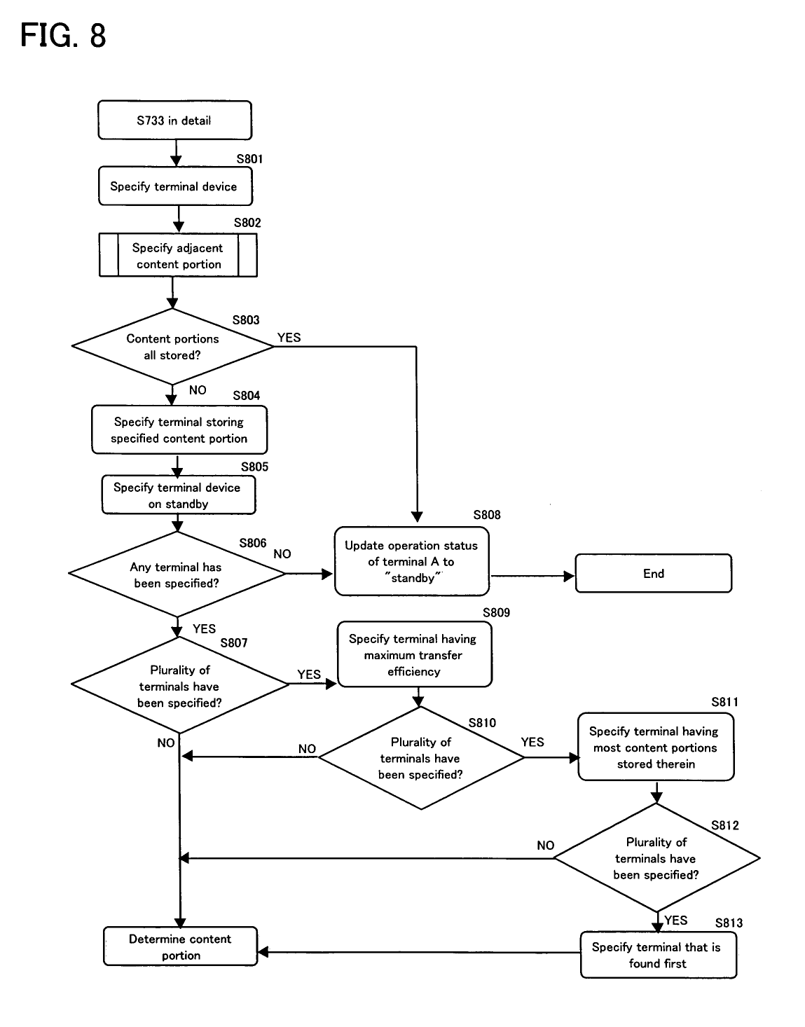

FIG. 8 shows the content portion specifying process (S733) in detail. In S801, the center server 4 specifies the terminal device A to which a content portion receiving instruction is issued, and refers to the entry for the terminal name “A” in the terminal information table. The center server 4 determines that the content portions stored in the terminal device A are Z2 to Z4. In S802, the center server 4 specifies a content portion to be received by and stored in the terminal device A. Specifically, the center server 4 specifies a content portion that is immediately before or immediately after a content portion already stored in the terminal device A.

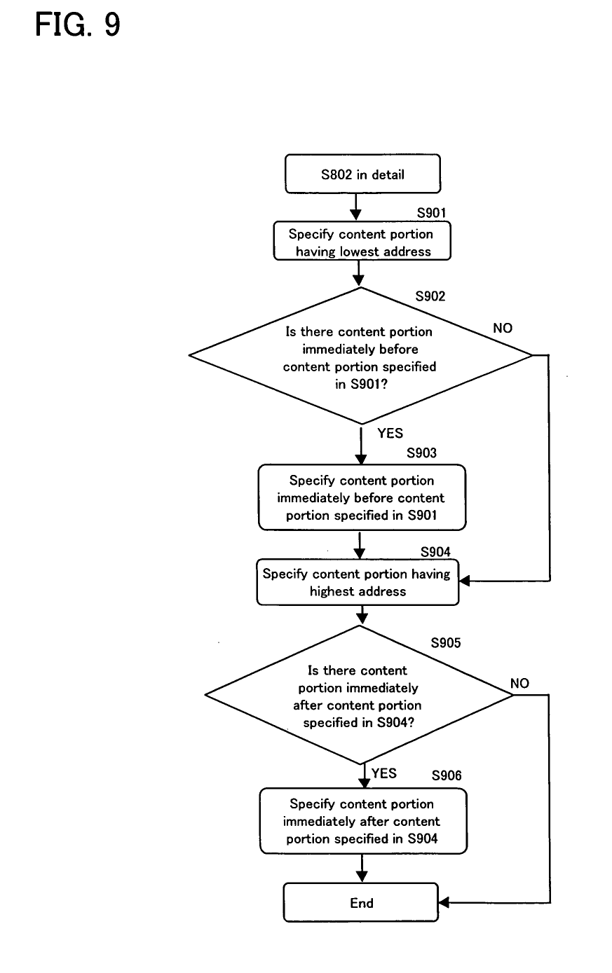

FIG. 9 shows the process of S802 in detail. In S901, the center server 4 specifies a content portion having the lowest address (smallest content portion ID) from among all the content portions stored in the terminal device A, i.e., the content portion Z2. In other words, the center server 4 specifies the earliest content portion Z2. In S902, the center server 4 refers to the content divisor table and determines whether or not there exists a content portion that is assigned a content portion ID immediately before that of the content portion Z2 (a content portion having an address immediately before that of the content portion Z2), i.e., the content portion Z1. Specifically, referring to the content divisor table, the center server 4 learns that the divisor for the content item Z is 8 and there are content portions Z1 to Z8, and the center server 4 in S903 specifies the content portion Z1 as a content portion that is assigned a content portion ID immediately before that of the content portion Z2.

Similarly, in S904, the center server 4 specifies a content portion having the highest address (largest content portion ID) from among all the content portions stored in the terminal device A, i.e., the content portion Z4. In S905, the center server 4 refers to the content divisor table and determines whether or not there exists a content portion that is assigned a content portion ID immediately after that of the content portion Z4 (a content portion having an address immediately after that of the content portion Z4), i.e., the content portion Z5. Specifically, since the divisor for the content item Z is 8 and there are content portions Z1 to Z8, the center server 4 in S906 specifies the content portion Z5 as a content portion that is assigned a content portion ID immediately after that of the content portion Z4.

Note that if the terminal device A already has the content portions Z3 to Z8 stored therein, for example, it is determined in S905 that a content portion Z9 does not exist, whereby the center server 4 specifies only the content portion Z2, which is immediately before the content portions stored in the terminal device A.

Referring back to FIG. 8, in S803, the center server 4 determines whether or not the terminal device A has all of the content portions Z1 to Z8 of the content item Z stored therein. Specifically, it is determined whether or not the process of FIG. 9 successfully specifies a content portion adjacent to (immediately before or immediately after) the content portions stored in the terminal device A. If not, it is determined that the terminal device A has all of the content portions stored therein. If the terminal device A has all of the content portions stored therein (YES in S803), the center server 4 updates the operation status information of the terminal device A to “standby” in the terminal information table (S808), and exits the process. In the illustrated example, the terminal device A does not yet have all of the content portions stored therein (NO in S803), whereby the process proceeds to S804.

In S804, the center server 4 specifies terminal devices storing the content portion Z1 and/or the content portion Z5 as specified in S802, referring to the content portion ID field of the terminal information table of Table 1 above. In the illustrated example, the center server 4 determines that the terminal device B has the content portion Z1 stored therein, and the terminal devices C, E and F have the content portion Z5 stored therein.

In S805, the center server 4 selects terminal devices whose operation status information is “standby” from among the terminal devices specified in S804. In other words, the center server 4 excludes terminal devices whose operation status information is not “standby”, from terminal devices to send the content portion to the terminal device A. This is for preventing terminal devices that are not on “standby” from sending content portions, thus increasing the load on the terminal devices. Specifically, the center server 4 refers to the operation status information in the terminal information table to specify the terminal devices B, E and F being on “standby” and exclude the terminal device C being “active”.

In S806, the center server 4 determines whether or not terminal devices whose operation status information is “standby” have been specified in S805. If no terminal device on “standby” has been specified (NO in S806), the center server 4 updates the operation status information of the terminal device A to “standby” in S808, and exits the process. Thus, if there is no terminal device on “standby” that stores the content portion to be stored next in the terminal device A, the center server 4 does not instruct terminal devices to send/receive the content portion. In the illustrated example, terminal devices being on “standby” are specified (YES in S806), whereby the process proceeds to S807.

In S807 to S813, if there are a plurality of terminal devices storing the content portion Z1 or Z5 to be received by the terminal device A, one of the terminal devices for sending the content portion to the terminal device A is selected as follows. In S807, it is determined if there are a plurality of terminal devices storing the content portion Z1 or Z5. In the illustrated example, there are a plurality of terminal devices (B, E and F), thus proceeding to S809.

In S809, the center server 4 specifies, as a terminal device for sending the content portion to the terminal device A, a terminal device having the highest transfer efficiency when sending a content portion to the terminal device A. This is for shortening the amount of time required before the content portion is completely stored in the terminal device A. The center server 4 refers to the terminal transfer efficiency table and the terminal information table to determine that the transfer efficiency with which a content portion is sent from the terminal devices B and F (the telecommunications carrier B) to the terminal device A (the telecommunications carrier B) is higher than the transfer efficiency with which a content portion is sent from the terminal device E (the telecommunications carrier C) to the terminal device A. Therefore, the center server 4 specifies the terminal devices B and F as terminal devices for sending the content portion to the terminal device A. In S810, it is determined as in S807 whether or not there are a plurality of terminal devices that have been specified as terminal devices for sending the content portion to the terminal device A. In the illustrated example, a plurality of terminal devices (B and F) have been specified, thus proceeding to S811.

In S811, the center server 4 specifies, as a terminal device for sending the content portion to the terminal device A, a terminal device that has most content portions of the content item Z stored therein. A terminal device having more content portions of a content item already stored therein will have to receive and store fewer content portions of that content item from other terminal devices. Therefore, it is determined so that the terminal device A receives desired content portions of the content item Z from terminal devices having more content portions of the content item Z already stored therein. In other words, a terminal device having fewer content portions of the content item Z stored therein is specified as a recipient of the remaining content portions of the content item Z as much as possible, instead of being specified as a sender of the content portions already stored therein. Thus, it is possible to shorten the total amount of time required before all content portions of a content item are completely stored in all terminal devices. In the illustrated example, the center server 4 refers to the terminal information table to specify the terminal device F as a terminal device for sending the content portion to the terminal device A. In S812, it is determined that a plurality of terminal devices have not been specified. Thus, the terminal device F is finally specified as a sender.

If a plurality of terminal devices are being specified after S811 (YES in S812), the center server 4 in S813 specifies, as the terminal device for sending the content portion to the terminal device A, one of the candidate terminal devices that is registered in the earliest entry in the terminal information table (i.e., one of the candidate terminal devices that is found first in a search operation).

Referring back to FIG. 7, the center server 4 in S734 instructs the terminal device A to receive the content portion specified in S733. Specifically, the center server 4 sends the terminal device A a content portion receiving command containing the content portion ID of the content portion to be received (Z5), and the IP address of the terminal device F, from which the content portion is to be sent. The terminal device A receives the content portion receiving command (S702), and sends the operation status information (“active”) to the center server 4 (S703). The center server 4 receives the operation status information, and updates the operation status information of the terminal device A in the terminal information table from “ready” to “active” (S735).

In S704, the terminal device A requests the terminal device F to send the content portion. Specifically, the terminal device A sends the terminal device F a content portion requesting command containing the content portion ID of the content portion to be received (Z5). The terminal device F receives the content portion requesting command (S751), and sends the operation status information (“active”) to the center server 4 (S752). The center server 4 receives the operation status information, and updates the operation status information of the terminal device F in the terminal information table from “standby” to “active” (S736). Since the operation status information of the terminal devices A and F in the terminal information table are now both “active”, other content portion receiving instructions will not be given to the terminal devices A and F from the center server 4. Thus, it is possible to prevent an increase in the load on the terminal devices A and F.

In S753, the terminal device F sends the content portion Z5 to the terminal device A. The terminal device A receives the content portion Z5 from the terminal device F, and stores the content portion Z5 in the local storage device 42 (S705). When the terminal device F has completely sent the content portion Z5 to the terminal device A, the terminal device F sends the operation status information (“standby”) to the center server 4 (S754). Then, the center server 4 receives the operation status information, and updates the operation status information of the terminal device F in the terminal information table from “active” to “standby” (S737). Similarly, when the terminal device A has completely received and stored the content portion Z5 from the terminal device F, the terminal device A sends the operation status information (“content portion received; standby”) to the center server 4 (S706). Then, the center server 4 receives the operation status information, and updates the operation status information of the terminal device A in the terminal information table from “active” to “standby” (S737). Since the operation status information of the terminal devices A and F in the terminal information table are now both “standby”, the center server 4 is again allowed to specify the terminal devices A and F in the content portion specifying process S733. Moreover, upon receiving the operation status information from the terminal device A, the center server 4 updates the terminal information table by adding “Z5” to the content portion ID field in the entry for the terminal device A. Therefore, the terminal device A will be next instructed to receive the content portion Z1 or Z6. The terminal devices A and F will send the operation status information (“ready”) to the center server 4 after being on “standby” for a predetermined amount of time, whereby the terminal devices A and F can receive and store content portions from other terminal devices. These operations are repeated for all the terminal devices, and the terminal devices successively receive and store content portions, until all of the content portions are stored in all of the terminal devices.

In the present embodiment, the content server sends different content portions to different terminal devices, after which each terminal device receives and stores, from other terminal devices, content portions immediately before or immediately after the content portion already stored therein. Therefore, it is possible to prevent the load from being concentrated at the content server or at a particular terminal device. The center server specifies a terminal device to send a content portion stored therein to a recipient terminal device based on the terminal information table, whereby it is possible to better reduce the load on terminal devices.

Another preferred embodiment of the present invention will now be described. Like elements to those of the previous embodiment will not be further described below. In the present embodiment, the center server 4 determines whether a larger number of earlier content portions (content portions closer to the content portion Z1) are yet to be received by the terminal devices A to H or a larger number of later content portions (content portions closer to the content portion Z8) are yet to be received by the terminal devices A to H. Then, the center server 4 specifies, as a content portion to be received next by the terminal device A, a content portion of the earlier group or the later group whichever is the larger group of un-received content portions. Therefore, it is possible to prevent the terminal devices from receiving more earlier content portions or more later content portions in an unbalanced manner for the system as a whole.

Table 6 below shows the terminal information table used in the present embodiment, which includes additional fields to Table 1 above: the number of remaining earlier portions, the number of remaining later portions, and the difference value. These values may be either received from the terminal devices or calculated by the center server 4 based on the content portion ID field of the terminal information table.

TABLE 6
TERMINAL INFORMATION TABLE

| | | Number of | Number of | | | | |
|---|---|---|---|---|---|---|---|
| | | remaining | remaining | | | | |
| Terminal | | earlier | later | Difference | Network | IP | Operation |
| name | Content portion ID | portions | portions | value | condition | address | status |
| A | Z2, Z3, Z4 | 1 | 4 | −3 | Carrier B | 10.1.0.2 | Ready |
| B | Z1, Z2, Z3 | 0 | 5 | −5 | Carrier B | 10.1.1.9 | Standby |
| C | Z5, Z6, Z7 | 4 | 1 | 3 | Carrier C | 10.2.2.1 | Active |
| D | Z7, Z8 | 6 | 0 | 6 | Carrier B | 10.1.1.8 | Standby |
| E | Z3, Z4, Z5, Z6, Z7 | 2 | 1 | 1 | Carrier C | 10.2.2.3 | Standby |
| F | Z3, Z4, Z5, Z6 | 2 | 2 | 0 | Carrier B | 10.1.2.7 | Standby |
| G | Z8 | 7 | 0 | 7 | Carrier B | 10.1.1.6 | Active |
| H | Z2 | 1 | 6 | −5 | Carrier B | 10.1.0.4 | Active |
| I | | | | | Carrier A | 10.0.0.3 | Active |
| J | | | | | Carrier C | 10.2.2.2 | Active |

The number of remaining earlier portions is the number of content portions in the earlier group (content portions closer to the content portion Z1) that have not been stored in the terminal device. The number of remaining later portions is the number of content portions in the later group (content portions closer to the content portion Z8) that have not been stored in the terminal device. The difference value indicates whether there are more un-received content portions in the earlier group or in the later group, and is obtained by subtracting the number of remaining later portions from the number of remaining earlier portions. The difference value being a positive value indicates that there are more un-received content portions in the earlier group than in the later group. The difference value being a negative value indicates that there are more un-received content portions in the later group than in the earlier group. For example, for the terminal device A having the content portions Z2 to Z4 already stored therein, the number of remaining earlier portions is 1, the number of remaining later portions is 4, and the difference value is −3.

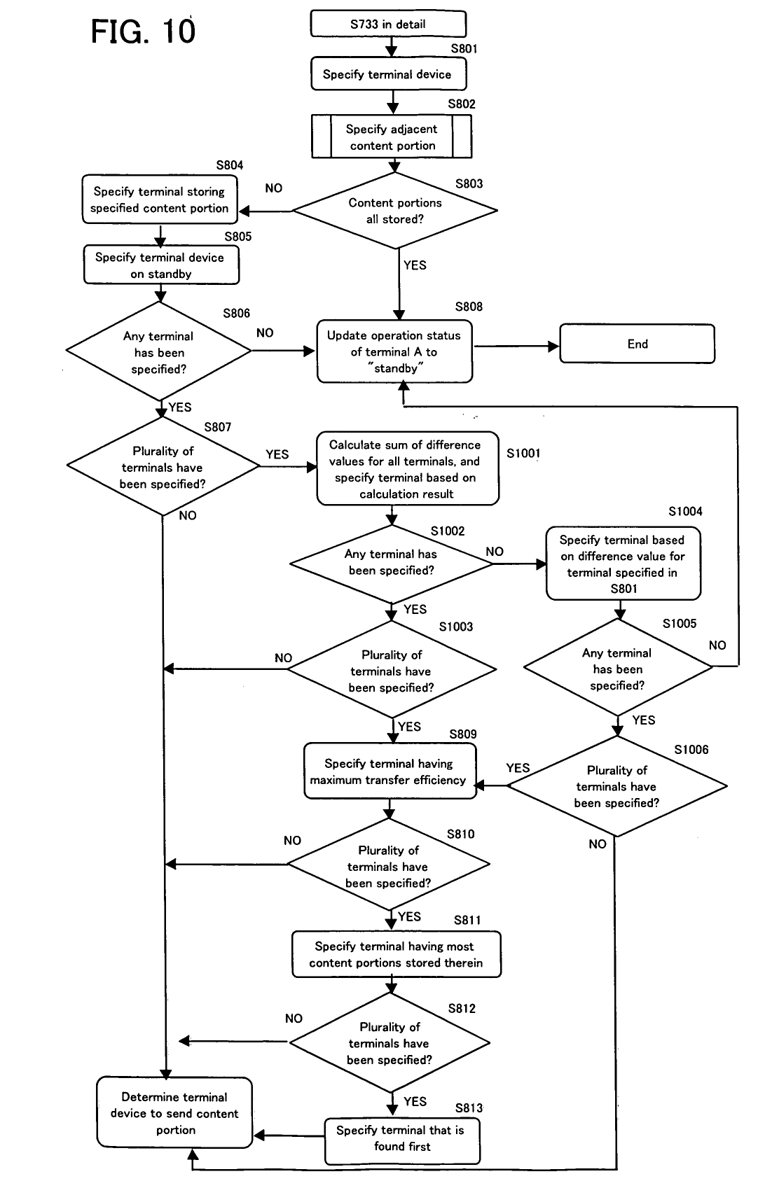

An operation of the present embodiment will now be described with reference to the flow chart of FIG. 10. Like steps to those shown in FIG. 8 will be denoted by like reference numerals and will not be further described below. In FIG. 10, steps S1001 to S1006 are added. In S807, the center server 4 specifies a plurality of terminal devices (B, E and F) as terminal devices having the content portion Z1 or Z5 stored therein, and the process proceeds to S1001. The center server 4 obtains the sum of the difference values of all the terminal devices A to H, and selects terminal devices for sending a content portion to the terminal device A based on the sum (S1001). Specifically, if the sum of the difference values of all the terminal devices is a positive value, the center server 4 determines that, for the terminal devices A to H as a whole, the number of remaining earlier portions is larger than the number of remaining later portions. Then, the center server 4 determines that the terminal device A should next receive and store the content portion Z1 being a content portion in the earlier group, and the center server 4 specifies a terminal device having the content portion Z1 stored therein from among the terminal devices B, E and F. If the sum of the difference values is a negative value, the center server 4 determines that, for the terminal devices A to H as a whole, the number of remaining later portions is larger than the number of remaining earlier portions. Then, the center server 4 determines that the terminal device A should next receive and store the content portion Z5 being a content portion in the later group, and the center server 4 specifies a terminal device having the content portion Z5 stored therein from among the terminal devices B, E and F. In the illustrated example, the sum of the difference values is 4, and the center server 4 accordingly specifies the terminal device B storing the content portion Z 1 being a content portion in the earlier group. It is determined in SI 002 that the center server 4 has specified at least one terminal device (YES in S1002), and it is determined that the center server 4 has not specified a plurality of terminal devices (NO in SI 003), whereby it is determined that the terminal device B is to send the content portion Z1 to the terminal device A. If the center server 4 has determined a plurality of terminal devices (YES in S1003), the process proceeds to S809 to further narrow down the candidate terminal devices.

For example, if there is no terminal device storing the content portion Z1 and it is determined in S1002 that no terminal device has been specified, the center server 4 specifies a terminal device for sending a content portion to the terminal device A based on the difference value for the terminal device A, which has been specified in S801 (S1004). Specifically, if the difference value for the terminal device A is a positive value, the center server 4 determines that the number of remaining earlier portions is larger than the number of remaining later portions for the terminal device A. Then, the center server 4 determines that the terminal device A should next receive and store the content portion Z1 being a content portion in the earlier group, and the center server 4 specifies a terminal device having the content portion Z1 stored therein from among the terminal devices B, E and F. If the difference value for the terminal device A is a negative value, the center server 4 determines that the number of remaining later portions is larger than the number of remaining earlier portions for the terminal device A. Then, the center server 4 determines that the terminal device A should next receive and store the content portion Z5 being a content portion in the later group, and the center server 4 specifies a terminal device having the content portion Z5 stored therein from among the terminal devices B, E and F. In the illustrated example, the difference value is −3, whereby the center server 4 specifies the terminal devices E and F storing the content portion Z5 being a content portion in the later group. It is determined that the center server 4 has specified at least one terminal device (YES in S1005) and it is determined that that the center server 4 has specified a plurality of terminal devices (YES in S1006), whereby the process proceeds to S809 to further narrow down the candidate terminal devices. If it is determined in S1006 that only one terminal device has been specified, the center server 4 specifies the terminal device as a terminal device for sending the content portion to the terminal device A. If it is determined after S1004 that no terminal device has been specified (NO in S1005), the process proceeds to S808 to update the operation status of the terminal device A to “standby”, and exits the process.

In the present embodiment, it is first determined for all of the terminal devices as a whole whether there are more content portions yet to be received by terminal devices in the earlier group or in the later group, and the process is controlled so that content portions of the earlier group or the later group whichever is the larger group of un-received content portions are preferentially received and stored in terminal devices. Therefore, it is possible to prevent the terminal devices from receiving more earlier content portions or more later content portions in an unbalanced manner for all of the terminal devices as a whole. For example, if the number of later content portions received and stored in terminal devices is significantly larger than the number of earlier content portions received and stored in terminal devices for all of the terminal devices as a whole, many terminal devices will later be requesting earlier content portions at the same time while there are only a few terminal devices having earlier content portions stored therein, whereby content portion requests will be concentrated at terminal devices having earlier content portions stored therein. The present embodiment can solve such a problem. If no terminal device can be specified as a sender based on the difference values for all of the terminal devices as a whole, the process is controlled so that content portions of the earlier group or the later group whichever is the larger group of un-received content portions for the terminal device A are preferentially received and stored in the terminal device A. Therefore, it is possible to prevent the terminal device A from receiving more earlier content portions or more later content portions in an unbalanced manner. By performing such an operation for all of the terminal devices, it is possible to prevent terminal devices from receiving more earlier content portions or more later content portions in an unbalanced manner for all of the terminal devices as a whole.

While preferred embodiments of the present invention have been described above, the present invention is not limited thereto. For example, in S811, the center server 4 may specify, as a sender, a terminal device that has least content portions stored therein. A terminal device having fewer content portions stored therein is less likely to be sending content portions to other terminal devices because of the smaller number of different content portions being stored therein. A terminal device having more content portions stored therein is more likely to be sending content portions to other terminal devices. Therefore, terminal devices having many content portions stored therein may be left on “standby” so that other terminal devices can retrieve content portions therefrom. Thus, it is possible to maximize the number of terminal devices that can be receiving content portions from other terminal devices at the same time, whereby it is possible to shorten the amount of time required before all content portions of a content item are completely stored in all terminal devices. While the center server instructs the terminal device A to receive a content portion in the embodiments above, the center server may alternatively instruct the terminal device F to send a content portion, in response to which the terminal device F can automatically send the content portion to the terminal device A without being requested by the terminal device A. Note that the present invention is also directed to a program for instructing a computer to perform operations as described above, and a recording medium storing such a program.

In the content distribution system of the present invention, a terminal device receives, from other terminal devices, a content portion adjacent to content portions already stored in the terminal device, whereby it is possible to prevent content requests from being concentrated at the content server or a particular terminal device.

The present invention is suitable for content distributing business in which content items are sent from a center server and a content server of a carrier to terminal devices provided in users' houses.

What is claimed is:

1. A content distribution system, comprising a center server and a plurality of terminal devices connectable to the center server, wherein
the center server includes a section for specifying, from among a plurality of content portions into which a content item is divided, a target content portion to be received next by a recipient terminal device being one of the plurality of terminal devices, the target content portion being immediately before or immediately after one or more content portions already stored in the recipient terminal device;
the center server includes a section for specifying a sender terminal device being one of the plurality of terminal devices that stores the specified target content portion; and
each terminal device includes a section for receiving and storing the specified target content portion from the specified sender terminal device.

2. The content distribution system according to claim 1, further comprising a content server to which the plurality of terminal devices can be connected, wherein:
the content server includes a section for storing the content portions;
the content server includes a section for sending each of the content portions to a different terminal device; and
each terminal device includes a section for storing the content portion sent from the content server.

3. A center server to which a plurality of terminal devices can be connected, comprising:
a section for specifying, from among a plurality of content portions into which a content item is divided, a target content portion to be received next by a recipient terminal device being one of the plurality of terminal devices, the target content portion being immediately before or immediately after one or more content portions already stored in the recipient terminal device; and
a section for specifying one of the plurality of terminal devices that stores the specified target content portion, as a sender terminal device for sending the specified target content portion to the recipient terminal device.

4. The center server according to claim 3, further comprising a section for receiving and storing operation status information from each of the terminal devices,
wherein the sender terminal device specifying section specifies the sender terminal device based on the operation status information of the terminal devices.

5. The center server according to claim 3, wherein if there are a plurality of terminal devices specified as sender terminal devices, the sender terminal device specifying section narrows down the sender terminal devices based on a transfer efficiency between the recipient terminal device and each sender terminal device.

6. The center server according to claim 3, further comprising a section for storing a difference value between the number of remaining earlier portions and the number of remaining later portions for each terminal device, wherein the number of remaining earlier portions represents the number of earlier content portions that have not been stored in the terminal device and the number of remaining later portions represents the number of later content portions that have not been stored in the terminal device,
wherein the content portion specifying section chooses either a content portion immediately before the one or more already-stored content portions or a content portion immediately after the one or more already-stored content portions based on a sum of the difference values for all the terminal devices.

7. The center server according to claim 6, wherein if the sender terminal device cannot be specified, the content portion specifying section chooses either a content portion immediately before the one or more already-stored content portions or a content portion immediately after the one or more already-stored content portions based on the difference value for the recipient terminal device.

8. The center server according to claim 3, being connectable to a content server storing the content item and further comprising:
a section for calculating a divisor being the number of portions into which the content item is divided, based on a bandwidth of a communications line to which the content server is connected and a transfer rate at which the content item is sent from the content server;
a section for instructing the content server to divide the content item into a plurality of content portions based on the calculated divisor; and
a section for instructing each terminal device to receive different one of the content portions from the content server.

9. A terminal device connectable to a center server, the center server being capable of specifying, from among a plurality of content portions into which a content item is divided, a target content portion to be received next by the terminal device, the target content portion being immediately before or immediately after one or more content portions already stored in the terminal device, and capable of specifying, from among a plurality of terminal devices, a sender terminal device that stores the specified target content portion, the terminal device comprising:
a receiving section for receiving and storing the specified target content portion from the specified sender terminal device; and
a sending section for sending the one or more content portions already stored in the terminal device to another terminal device.

10. A computer program for a center server to which a plurality of terminal devices can be connected, the computer program instructing the center server to perform the steps of:
specifying, from among a plurality of content portions into which a content item is divided, a target content portion to be received next by a recipient terminal device being one of the plurality of terminal devices, the target content portion being immediately before or immediately after one or more content portions already stored in the recipient terminal device; and
specifying one of the plurality of terminal devices that stores the specified target content portion, as a sender terminal device for sending the specified target content portion to the recipient terminal device.

11. A computer program for a terminal device connectable to a center server, the center server being capable of specifying, from among a plurality of content portions into which a content item is divided, a target content portion to be received next by the terminal device, the target content portion being immediately before or immediately after one or more content portions already stored in the terminal device, and being capable of specifying, from among a plurality of terminal devices, a sender terminal device that stores the specified target content portion, the computer program instructing the terminal device to perform the steps of:
receiving and storing the specified target content portion from the specified sender terminal device; and
sending the one or more content portions already stored in the terminal device to another terminal device.
